(19) United States
(12) Patent Application Publication
(10) Pub. No.: US 2019/0376271 A1
(43) Pub. Date: Dec. 12, 2019

(54) Drain cleaning tool

(71) Applicant: Warren J. Null, Southbury, CT (US)

(72) Inventor: Warren J. Null, Southbury, CT (US)

(21) Appl. No.: 15/998,383

(22) Filed: Aug. 14, 2018

Related U.S. Application Data
(60) Provisional application No. 62/763,278, filed on Jun. 11, 2018.

(51) Int. Cl. E03F 9/00; E03C 1/302; B08B 9/045; B08B 9/043

(52) U.S. Cl. CPC E03F 9/005; B08B 9/0436; B08B 9/045; E03C 1/302

(57) ABSTRACT

It is a drain cleaning tool for cleaning blockages. The tool is shaped like a T with a hook at the bottom. It is made of a flexible steel rod ⅛ inches (plus or minus) and 24 inches long. This tool is so simple to use a child can do it by lowering it into the drain, turning it and pulling it out.

### BACKGROUND OF THE INVENTION

This invention relates to a hand tool for cleaning drains including shower, bathtub, sink, etc.

### BRIEF DESCRIPTION OF THE VIEWS OF THE DRAWINGS

Flexible steel rod ⅛ inch plus or minus in diameter, 24 inches long plus or minus, 4 inch welded T handle with 3 claws at the end that is 1 and ⅛ inches wide plus or minus.

FIG. 1 is a perspective view of the drain cleaning tool—also shows overhead view

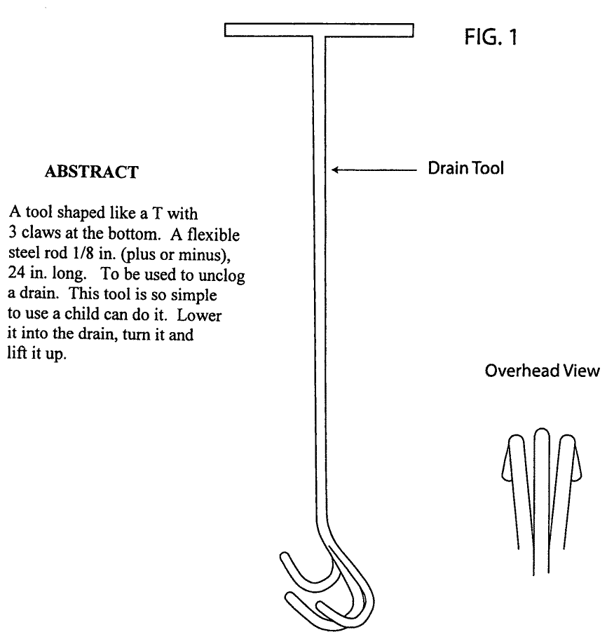

FIG. 2 shows the tool inside the drain used for cleaning blockages, hair, etc.

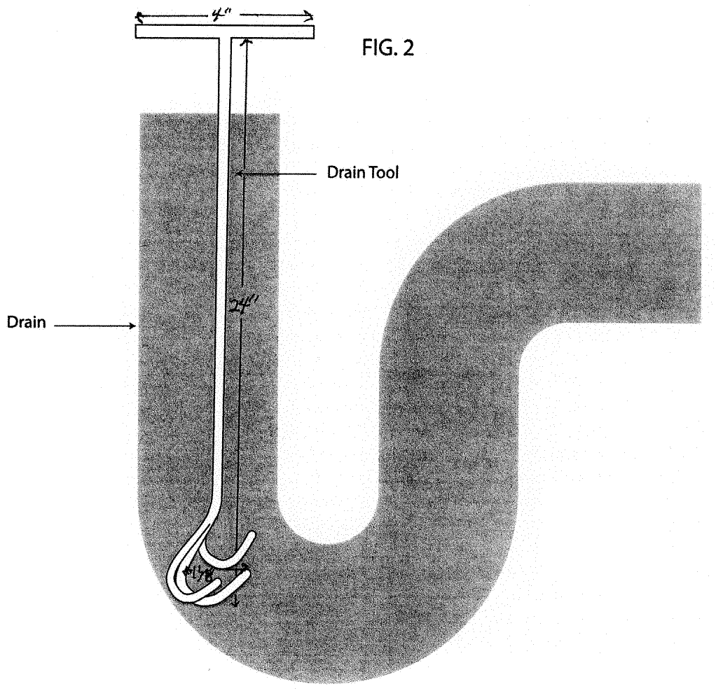

1. A tool used to clean a blockage from a drain. A flexible steel rod with a hook on the end.

2. This tool is so simple to use a child can do it. Lower it into the drain, turn it and lift it up.

3. This tool should last a lifetime.

4. This tool may be adjusted to fit any size drain by either opening or closing the hook with a pair of pliers.
